(19) United States
(12) Patent Application Publication
(10) Pub. No.: US 2011/0107769 A1
(43) Pub. Date: May 12, 2011

(54) IMPINGEMENT INSERT FOR A TURBOMACHINE INJECTOR

(75) Inventors: Christian Xavier Stevenson, Inman, SC (US); Thomas Edward Johnson, Greer, SC (US); Kevin Weston McMahan, Greer, SC (US); William David York, Greer, SC (US)

(73) Assignee: GENERAL ELECTRIC COMPANY, Schenectady, NY (US)

(21) Appl. No.: 12/614,884

(22) Filed: Nov. 9, 2009

(51) Int. Cl. F02C 7/22

(52) U.S. Cl. 60/772; 60/737

(57) ABSTRACT

A turbomachine includes a compressor, a turbine operatively coupled to the compressor, and a combustion assembly fluidly linking the compressor and the turbine. The combustion assembly includes at least one injector having a burner tube including an outer wall portion and an inner wall portion that define a mixing zone. A swirler arranged within the mixing zone. The swirler includes a plurality of vanes, with at least one of the plurality of vanes having a wall section including an outer surface and an inner surface that define a hollow interior portion. An insert member is arranged within the hollow interior portion. The insert member includes at least one guide element that is disposed and configured to deliver a fluid flow to the hollow interior portion to flow over the wall section of the at least one of the plurality of vanes.

### FEDERAL RESEARCH STATEMENT

This invention was made with Government support under Contract No. DE-FC26-05NT42643, awarded by the US Department of Energy (DOE). The Government has certain rights in this invention.

### BACKGROUND OF THE INVENTION

The subject matter disclosed herein relates to the art of turbomachines, and more particularly, to an impingement insert for a turbomachine injector.

Turbomachine injectors, in particular pre-mixed fuel injectors, incorporate swirler vanes to increase fuel/air mixing prior to combustion. Heat developed during combustion often times results in thermal damage to the swirler vanes. When fuel reactivities are increased, introducing fuel into an airflow may result in a flashback condition. Flashback occurs when a flame structure moves upstream from a desired location and into a pre-mixing section of a fuel injector. If flashback occurs, or if any ignition source passes into the injector, flameholding may result. Flameholding occurs when the flame structure finds an anchor point inside the injector. Should flameholding occur, internal injector components may be subjected to high thermal loads that could result in damage.

### BRIEF DESCRIPTION OF THE INVENTION

According to one aspect of the invention, a turbomachine includes a compressor, a turbine operatively coupled to the compressor, and a combustion assembly fluidly linking the compressor and the turbine. The combustion assembly includes at least one injector having a burner tube including an outer wall portion and an inner wall portion that defines a mixing zone, and a swirler arranged within the mixing zone. The swirler includes a plurality of vanes, with at least one of the plurality of vanes having a wall section including an outer surface and an inner surface that define a hollow interior portion. An insert member is arranged within the hollow interior portion. The insert member includes at least one guide element that is disposed and configured to deliver a fluid flow from the hollow interior portion to flow over the wall section of the at least one of the plurality of vanes.

According to another aspect of the invention, a method of conditioning a swirler vane in a turbomachine nozzle includes guiding a fluid flow along a plurality of swirler vanes, passing a portion of the fluid flow into an opening formed in at least one of the plurality of swirler vanes, introducing the portion of the fluid flow into a guide element of an insert member arranged within the at least one of the plurality of swirler vanes, and directing the portion of the fluid flow from the insert onto an internal surface of the at least one of the plurality of swirler vanes.

According to yet another aspect of the invention, a turbomachine injector includes a burner tube having an outer wall portion and an inner wall portion that define a mixing zone, a swirler arranged within the mixing zone. The swirler includes a plurality of vanes with at least one of the plurality of vanes having a wall section including an outer surface and an inner surface that define a hollow interior portion. An insert member is arranged within the hollow interior portion of the at least one of the plurality of vanes. The insert member includes at least one guide element that is disposed and configured to deliver a fluid flow to the hollow interior portion to flow over the wall section of the at least one of the plurality of vanes.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a turbomachine including an injector having a swirler provided with an impingement insert in accordance with an exemplary embodiment;

FIG. 2 is a partial cross-sectional view of a combustor portion of the turbomachine of FIG. 1;

FIG. 3 is partial cross-sectional view of a turbomachine injector including a swirler provided with an impingement insert in accordance with an exemplary embodiment;

FIG. 4 is a lower right perspective view of the swirler of FIG. 3;

FIG. 5 is partial cross-sectional view of the swirler of FIG. 4 illustrating fluid flow through the impingement insert;

FIG. 6 is an exploded view of a swirler vane and impingement insert of FIG. 5;

FIG. 7 is a cross-sectional view of a swirler vane including an impingement insert in accordance with an exemplary embodiment;

FIG. 8 is a is a cross-sectional view of a swirler vane including an impingement insert in accordance with another exemplary embodiment; and

FIG. 9 is a cross-sectional view of a swirler vane including an impingement insert in accordance with yet another exemplary embodiment.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a centerbody of a burner tube assembly. The terms “radial” and “radially” as used in this application refer to directions and orientations extending substantially orthogonally to the center longitudinal axis of the centerbody. The terms “upstream” and “downstream” as used in this application refer to directions and orientations relative to an axial flow direction with respect to the center longitudinal axis of the centerbody.

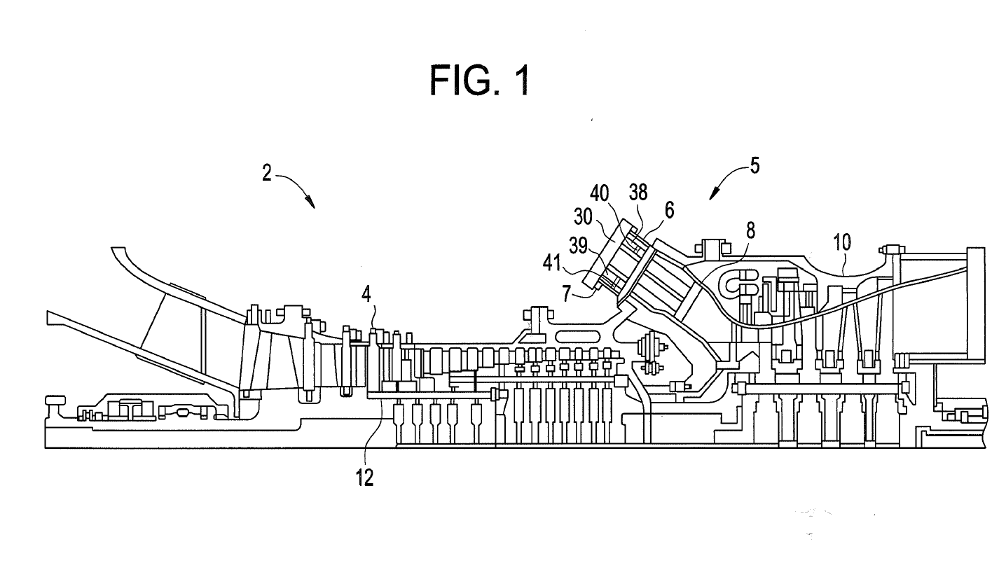

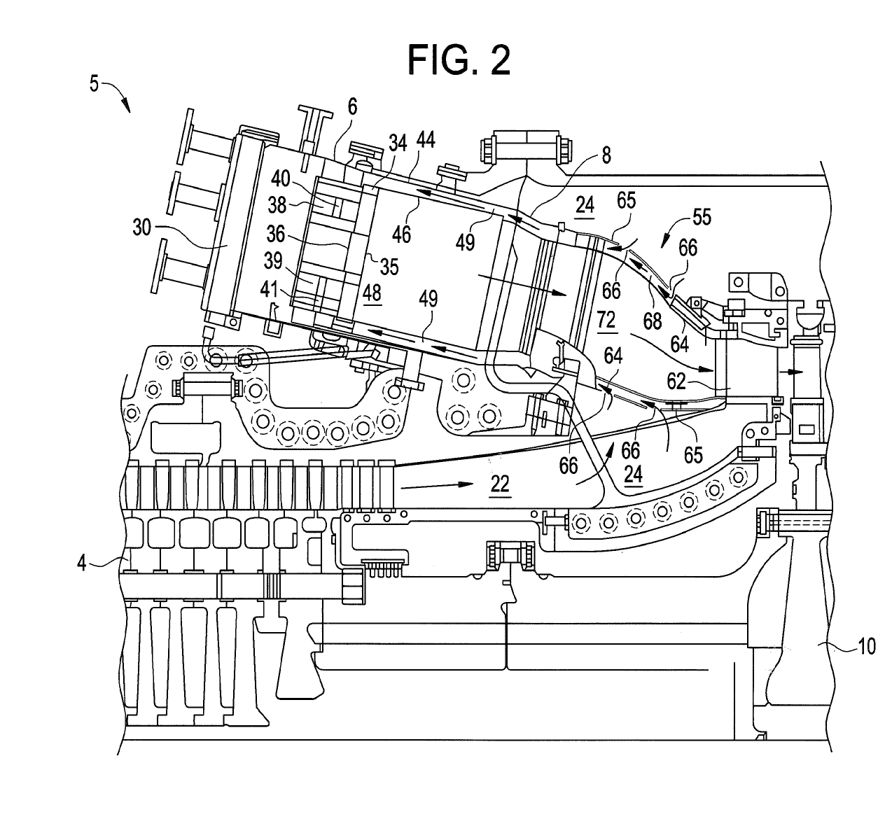

With initial reference to FIGS. 1 and 2, a turbomachine constructed in accordance with exemplary embodiments of the invention is generally indicated at 2. Turbomachine 2 includes a compressor 4 and a combustor assembly 5 having at least one combustor 6 provided with a fuel nozzle or injector assembly housing 8. Turbomachine 2 also includes a turbine 10 and a common compressor/turbine shaft or rotor 12. Combustor 6 is coupled in flow communication with compressor 4 and turbine 10. Compressor 4 includes a diffuser 22 and a compressor discharge plenum 24 that are coupled in flow communication with each other. Combustor 6 also includes an end cover 30 positioned at a first end thereof, and a cap member 34. Cap member 34 includes a first surface 35 and an opposing second surface 36. First surface 35 provides structural support to a plurality of fuel injectors, two of which are indicated at 38 and 39. As will be discussed more fully below, each injector includes a corresponding swirler 40 and 41. Swirlers 40 and 41 contribute to the mixing of fuel and air passing through injectors 38 and 39.

Combustor 6 is further shown to include a combustor casing 44 and a combustor liner 46. As shown, combustor liner 46 is positioned radially inward from combustor casing 44 so as to define a combustion chamber 48. An annular combustion chamber cooling passage 49 is defined between combustor casing 44 and combustor liner 46. A transition piece 55 couples combustor 6 to turbine 10. Transition piece 55 channels combustion gases generated in combustion chamber 48 downstream towards a first stage turbine nozzle 62. Towards that end, transition piece 55 includes an inner wall 64 and an outer wall 65. Outer wall 65 includes a plurality of openings 66 that lead to an annular passage 68 defined between inner wall 64 and outer wall 65. Inner wall 64 defines a guide cavity 72 that extends between combustion chamber 48 and turbine 10.

During operation, air flows through compressor 4 and compressed air is supplied to combustor 6 and, more specifically, to injectors 38 and 39. At the same time, fuel is passed to injectors 38 and 39 to mix with the air and form a combustible mixture. The combustible mixture is channeled to combustion chamber 48 and ignited to form combustion gases. The combustion gases are then channeled to turbine 10. Thermal energy from the combustion gases is converted to mechanical rotational energy that is employed to drive shaft 12.

More specifically, turbine 10 drives compressor 4 via shaft 12 (shown in FIG. 1). As compressor 4 rotates, compressed air is discharged into diffuser 22 as indicated by associated arrows. In the exemplary embodiment, the majority of air discharged from compressor 4 is channeled through compressor discharge plenum 24 towards combustor 6, and the remaining compressed air is channeled for use in cooling engine components. Compressed air within discharge plenum 24 is channeled into transition piece 55 via outer wall openings 66 and into annular passage 68. Air is then channeled from annular passage 68 through annular combustion chamber cooling passage 49 and to injectors 38 and 39. The fuel and air are mixed forming the combustible mixture that is ignited forming combustion gases within combustion chamber 48. Combustor casing 44 facilitates shielding combustion chamber 48 and the associated combustion processes from the outside environment such as, for example, surrounding turbine components. The combustion gases are channeled from combustion chamber 48 through guide cavity 72 and towards turbine nozzle 62. The hot gases impacting first stage turbine nozzle 62 create a rotational force that ultimately produces work from turbine 2.

At this point it should be understood that the above-described construction is presented for a more complete understanding of exemplary embodiments of the invention, which is directed to the particular structure of injectors 38 and 39 and, in particular, swirlers 40 and 41. However, as each injector 38, 39 is similarly formed, a detail description will follow referencing injector 38 with an understanding that injector 39 is similarly formed.

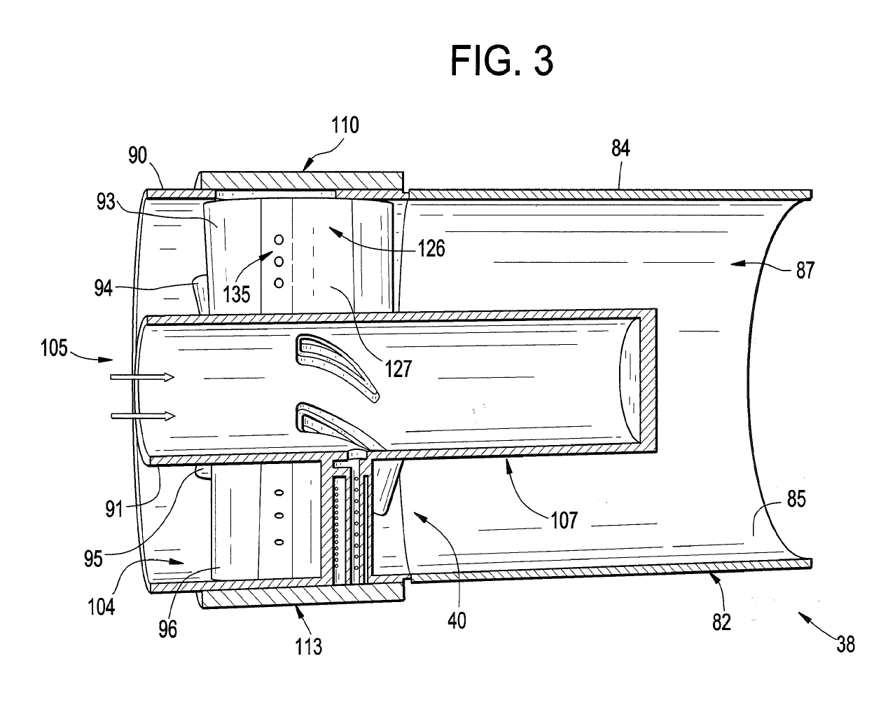

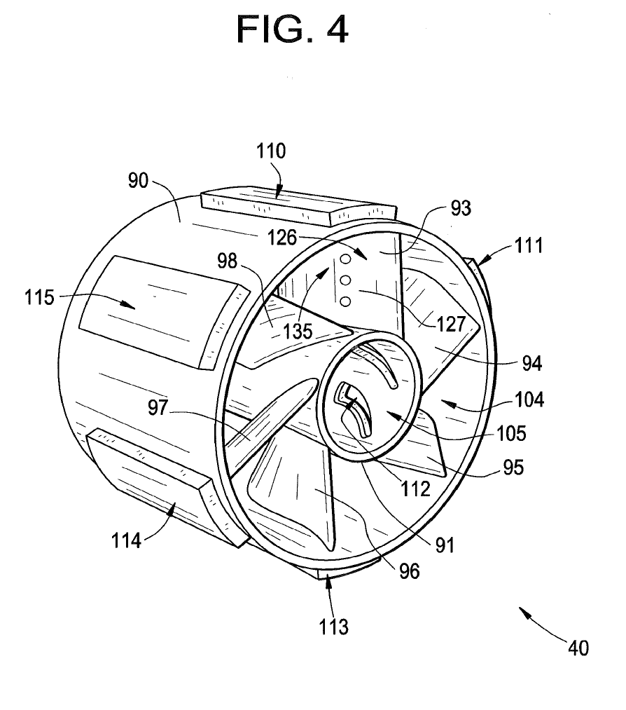

As best shown in FIGS. 3 and 4, injector 38 includes a burner tube 82 having an outer wall portion 84 and an inner wall portion 85 that define a mixing zone 87. With this arrangement, swirler 40 is arranged upstream of mixing zone 87 and is configured to create a turbulence in a fluid flow passing through injector 38. More specifically, swirler 40 includes a first wall portion 90 and a second wall portion 91 between which extend a plurality of vanes 93 through 98. Each vane 93-98 includes an air foil-shape that imparts a turbulence to fluid flow passing through swirler 40. In addition to supporting vanes 93-98, first and second wall portions 90 and 91 define corresponding outer and inner flow portions 104 and 105. Outer flow portion 104 leads to mixing zone 87 while inner flow portion 105 fluidly connects to a center body 107 that discharges fuel into mixing zone 87.

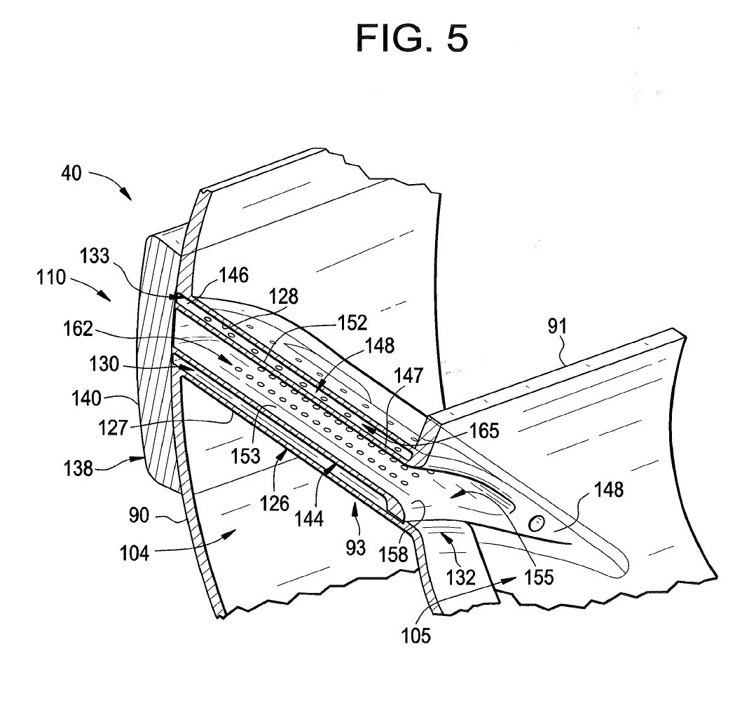

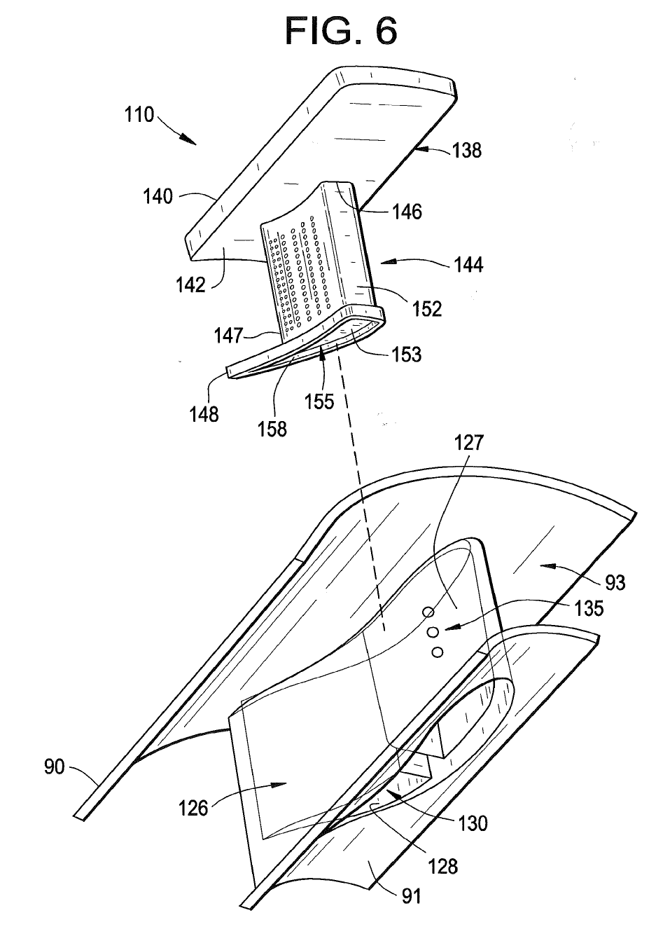

In accordance with an exemplary embodiment, each vane 93-98 includes a corresponding insert member 110-115. As will be discussed more fully below, each insert member 110-115 channels a conditioning fluid flow to internal portions of corresponding ones of vanes 93-98. At this point, a description will follow referencing FIGS. 5 through 7 in describing vane 93 and corresponding insert member 110 with an understanding that the remaining vanes 94-98 and insert members 111-115 are similarly formed.

As shown in FIGS. 3-6, vane 93 includes a wall section 126 having an outer surface 127 and an inner surface 128 that define a hollow interior portion 130. Vane 93 is further shown to include a first opening 132 arranged on second wall portion 91 and a second opening 133 arranged on first wall portion 90. With this arrangement, hollow interior portion 130 extends between first and second openings 132 and 133. In addition, wall section 126 is shown to include a plurality of discharge openings, one of which is indicated at 135, that extends between hollow interior portion 130 and mixing zone 87. With this arrangement insert 115 is mounted to outer wall portion 90 through opening 133 and into hollow interior portion 130 in a manner that will be described more fully below.

Insert member 110 includes a sealing pad or cap member 138 having a first or outer surface 140 and a second or inner surface 142. Inner surface 142 is contoured to correspond to a contour of first wall portion 90 of swirler 40. Insert member 110 is further shown to include a guide element 144 that extends from inner surface 142 of cap member 138. More specifically, guide element 144 includes a first end 146 that extends from inner surface 144 to a second end 147 that terminates in a flange 148. Guide element 144 is also shown to include an outer wall element 152 and an inner wall element 153 that define a flow passage 155 that extends between first and second ends 146 and 147. Guide element 144 is also shown to include an inlet 158 arranged at second end 147.

In the exemplary embodiments shown, inlet 158 corresponds to opening 132 formed in second wall portion 91. More specifically, flange 148 is configured to seal within hollow interior portion 130 at second wall portion 91 with inlet 158 registering with opening 132. Guide element 144 includes a plurality of openings 162 that extend between outer an inner wall elements 152 and 153 thereby fluidly connecting flow passage 155 and hollow interior portion 130. More specifically, outer wall element 152 is spaced from inner surface 128 of wall section 126 to define a conditioning flow channel 165. With this arrangement, fluid flowing through inner flow portion 105 enters inlet 158 and passes into flow passage 155. The fluid then passes through the plurality of openings 162 and impacts inner surface 128 to flow over wall section 126. In this manner, in the event that a flame migrates into mixing zone 87, exposure to the associated heat damage will not damage vanes 93-98 as a result of the conditioning flow. In any event, after passing into conditioning flow channel 165, the conditioning flow exits through discharge openings 135 back into mixing zone 87 to mix with another fluid prior to combustion.

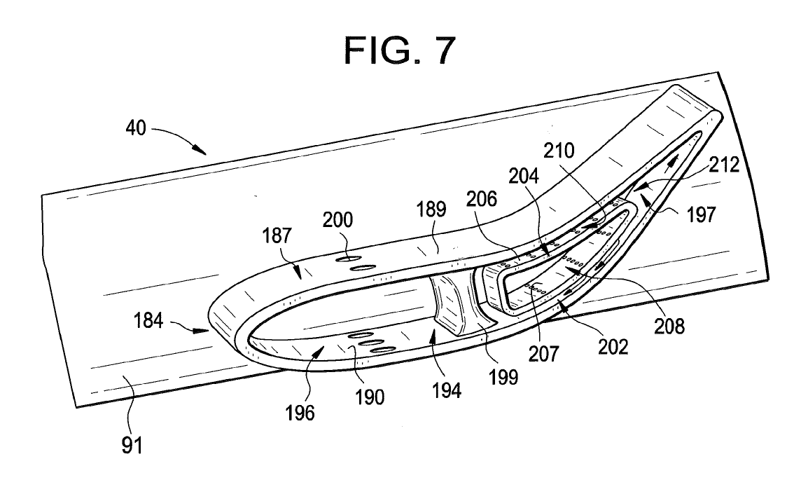

Reference will now be made to FIG. 7, wherein like reference numbers represent corresponding parts in the respective views, in describing a vane 184 in accordance with another exemplary embodiment. As shown, vane 184 includes a wall section 187 having an outer surface 189 and an inner surface 190 that define a hollow interior portion 194. In the exemplary embodiment shown, hollow interior portion 194 includes a first section 196 and a second section 197 that are separated by a baffle 199. Baffle 199 provides a flow impedance within hollow interior portion 194. With this arrangement, conditioning flow exits from vane 184 via discharge openings 200. Baffle 199 provides a flow impedance that ensures that the conditioning flow resides within hollow interior portion 194 for a period of time.

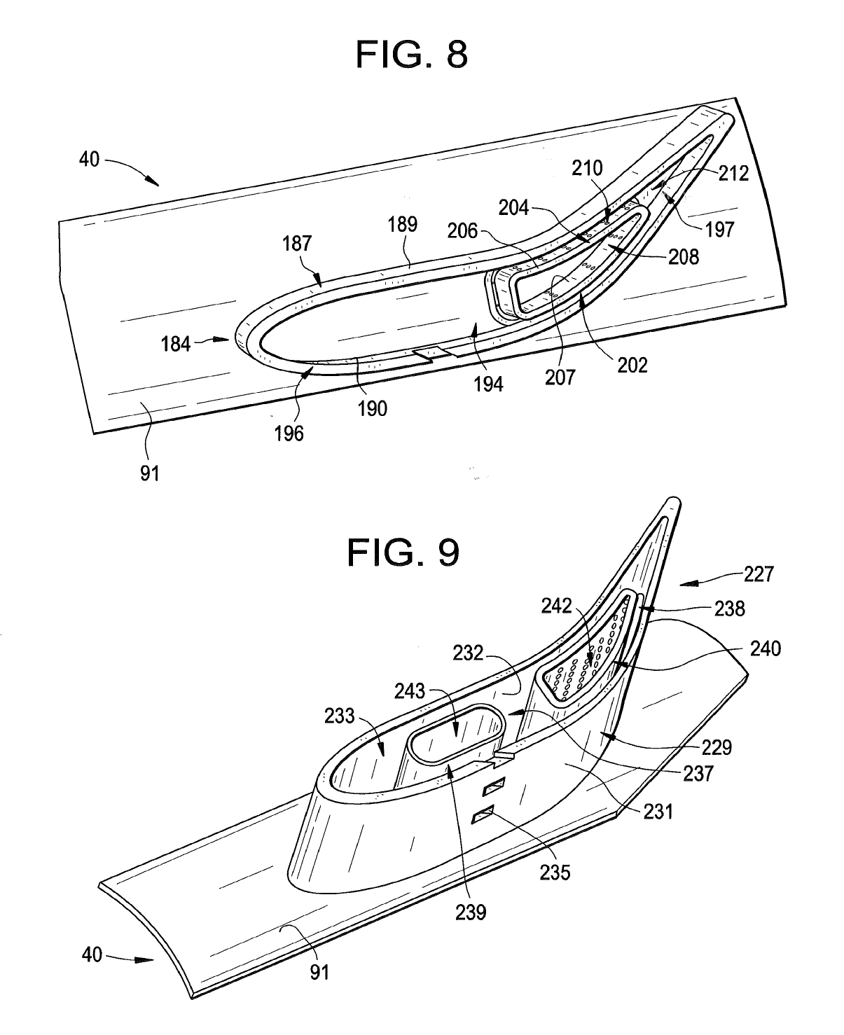

Vane 184 is also shown to include an insert member 202 having a guide element 204 that extends within first section 197 of hollow interior portion 194. Guide element 204 includes an outer wall element 206 and an inner wall element 207 that define a flow passage 208. In a manner similar to that described above, guide element 204 includes a plurality of openings 210 that extend between outer and inner wall elements 206, 207 to fluidly connect flow passage 208 with hollow interior portion 194. In a manner also similar to that described above, outer wall element 206 is spaced from inner surface 190 of wall section 187 thereby defining a conditioning flow channel 212. With this arrangement, conditioning flow passing into insert member 202 travels through guide element 204, through openings 210 and into conditioning flow channel 212. The flow then migrates from second section 197 to first section 196 prior to exiting into mixing zone 87 via discharge openings 200. FIG. 8 illustrates a similar arrangement without the incorporation of a baffle. That is, in the arrangement illustrated in FIG. 8, the conditioning flow passes directly from guide element 204 through hollow interior portion 194 prior to exiting from discharge openings 200 back to mixing zone 87 in a manner similar to that described above.

Reference will now be made to FIG. 9 wherein like reference numbers represent corresponding parts in the respective views in describing a vane 227 constructed in accordance with yet another exemplary embodiment. Vane 227 includes a wall section 229 having an outer surface 231 and an inner surface 232 that define a hollow interior portion 233. Vane 227 also includes a plurality of discharge openings, one of which is indicated at 235, which extend between inner and outer surfaces 231 and 232 of wall section 229. In the exemplary embodiment, vane 227 includes a first insert 237 and a second insert 238 that extend into hollow interior portion 233. First insert 237 includes a first guide element 239 while second insert 238 includes a second guide element 240. Each guide element 239, 240 includes a corresponding flow passage 242 and 243 that directs a fluid flow from inner flow portion 105 into hollow interior portion 233. While shown as multiple inserts including respective guide elements, it should be understood that guide elements 239 and 240 could be incorporated into a single insert. In any event, it should be readily apparent that the various aspects of the exemplary embodiments provide a conditioning of the air flow to internal portions of a swirler vane to ensure that heat associated with flashbacks and/or flame holding within a turbomachine injector is readily dissipated to limit/minimize damage to injector components. In addition, the conditioning of the airflow in accordance with the exemplary embodiment results in reduced combustion dynamics and enhanced combustion performance.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a turbine operatively coupled to the compressor; and
a combustion assembly fluidly linking the compressor and the turbine, the combustion assembly includes at least one injector having:
a burner tube including an outer wall portion and an inner wall portion that define a mixing zone;
a swirler arranged within the mixing zone, the swirler including a plurality of vanes, at least one of the plurality of vanes having a wall section including an outer surface and an inner surface defining a hollow interior portion; and
an insert member arranged within the hollow interior portion, the insert member including at least one guide element that is disposed and configured to deliver a fluid flow to the hollow interior portion to flow over the wall section of the at least one of the plurality of vanes.

2. The turbomachine according to claim 1, wherein the swirler includes an outer flow portion and an inner flow portion, the plurality of vanes extending between the outer and inner flow portions.

3. The turbomachine according to claim 2, wherein the hollow interior portion extends between the outer and inner flow portions.

4. The turbomachine according to claim 3, wherein the inner flow portion includes an opening that leads to the hollow interior portion.

5. The turbomachine according to claim 4, wherein the insert member includes an inlet that registers with the opening in the inner flow portion.

6. The turbomachine according to claim 2, wherein the insert member extends between the outer and inner flow portions.

7. The turbomachine according to claim 1, wherein the at least one guide element includes an outer wall element and an inner wall element that define a flow passage.

8. The turbomachine according to claim 7, wherein the at least one guide element includes a plurality of openings that extend between the flow passage and the outer wall element.

9. The turbomachine according to claim 7, further comprising: a conditioning flow channel extending between the outer wall element and the inner surface of the wall member.

10. The turbomachine according to claim 1, wherein the at least one guide element comprises two guide elements.

11. A method of conditioning a swirler vane in a turbomachine nozzle, the method comprising:
guiding a fluid flow along a plurality of swirler vanes;
passing a portion of the fluid flow into an opening formed in at least one of the plurality of swirler vanes;
introducing the portion of the fluid flow into a guide element of an insert member arranged within the at least one of the plurality of swirler vanes; and
directing the portion of the fluid flow from the insert member onto an internal surface of the at least one of the plurality of swirler vanes.

12. The method of claim 11, further comprising: passing the portion of the fluid flow into a flow passage that extends within the guide element.

13. The method of claim 12, further comprising: directing the portion of the fluid flow from the flow passage, through a plurality of openings formed in the guide element, and into a hollow interior portion of the at least one of the plurality of swirler vanes.

14. The method of claim 12, further comprising: passing the portion of the fluid flow through a conditioning flow channel that extends between the insert member and an inner surface of the at least one of the plurality of swirler vanes.

15. The method of claim 11, further comprising: directing the portion of the fluid flow through the at least one of the plurality of swirler vanes back into the fluid flow.

16. A turbomachine injector comprising:
a burner tube including an outer wall portion and an inner wall portion that define a mixing zone;
a swirler arranged within the mixing zone, the swirler including a plurality of vanes, at least one of the plurality of vanes having a wall section including an outer surface and an inner surface defining a hollow interior portion; and
an insert member arranged within the hollow interior portion, the insert member including at least one guide element that is disposed and configured to deliver a fluid flow to the hollow interior portion to flow over the wall section of the at least one of the plurality of vanes.

17. The turbomachine injector according to claim 16, wherein the at least one guide element includes an outer wall element and an inner wall element that define a flow passage.

18. The turbomachine injector according to claim 17, wherein the at least one guide element includes a plurality of openings that extend between the flow passage and the outer wall element.

19. The turbomachine injector according to claim 17, further comprising: a conditioning flow channel extending between the outer wall element and the inner surface of the wall member.

20. The turbomachine injector according to claim 17, wherein the at least one of the plurality of vanes includes at least one discharge opening that fluidly connects the conditioning flow channel and the mixing zone.
